(19) United States
(12) Patent Application Publication
(10) Pub. No.: US 2026/0021712 A1
(43) Pub. Date: Jan. 22, 2026

(54) ELECTRIC VEHICLE

(71) Applicant: TOYOTA JIDOSHA KABUSHIKI KAISHA, Toyota-shi (JP)

(72) Inventors: Masami KONDO, Oguchi-cho Niwa-gun Aichi-pre. (JP); Tadashi FUJIYOSHI, Anjo-shi (JP); Yoshio UENO, Izunokuni-shi (JP); Keisuke SASAKI, Nagakute-shi (JP); Daijiro KAWASAKI, Sunto-gun (JP); Takahiro YOKOKAWA, Susono-shi (JP)

(73) Assignee: TOYOTA JIDOSHA KABUSHIKI KAISHA, Toyota-shi (JP)

(21) Appl. No.: 19/050,353

(22) Filed: Feb. 11, 2025

(30) Foreign Application Priority Data
Jul. 18, 2024 (JP) 2024-115019

(51) Int. Cl. B60L 15/20; B60K 1/02

(52) U.S. Cl. CPC B60L 15/2036; B60K 1/02; B60L 2240/423

(57) ABSTRACT

An electric vehicle that has rotating electric machines for generating rotational driving forces to be applied to a left drive wheel and a right drive wheel of the electric vehicle and that travels in an automatic operation, includes a controller to, when determining that at least one of the left drive wheel and the right drive wheel is stacked during traveling in the automatic operation, perform, in response to the stack, driving force control for rotating and driving the left drive wheel and the right drive wheel by increasing and decreasing torques generated by the rotating electric machines.

### CROSS-REFERENCE TO RELATED APPLICATION(S)

The present application claims priority to and incorporates by reference the entire contents of Japanese Patent Application No. 2024-115019 filed in Japan on Jul. 18, 2024.

### BACKGROUND

The present disclosure relates to an electric vehicle.

Japanese laid-open Patent Publication No. 2022-161380 discloses a technique for transmitting driving force in an electric vehicle by extending the suspension of the driving wheels on the slipping side and grounding the ground.

### SUMMARY

There is a need for providing an electric vehicle that can easily escape from a stack during automatic operation running.

According to an embodiment, an electric vehicle that has rotating electric machines for generating rotational driving forces to be applied to a left drive wheel and a right drive wheel of the electric vehicle and that travels in an automatic operation, includes a controller to, when determining that at least one of the left drive wheel and the right drive wheel is stacked during traveling in the automatic operation, perform, in response to the stack, driving force control for rotating and driving the left drive wheel and the right drive wheel by increasing and decreasing torques generated by the rotating electric machines.

### BRIEF DESCRIPTION OF THE DRAWINGS

FIG. 1 is a schematic diagram illustrating an example of a configuration of an electric vehicle according to a first embodiment;

FIG. 2 is a block diagram illustrating an example of a schematic configuration of a control system in an electric vehicle according to a first embodiment;

FIG. 3 is a flowchart illustrating an example of stack determination and driving force control that are performed by a control device while the electric vehicle according to the first embodiment is traveling in an automatic operation;

FIG. 4 is a timing chart relating to driving force control for the stack in the first embodiment;

FIG. 5 is a view illustrating the state of driving wheels when the driving force control for the stack is executed;

FIG. 6 is a flowchart illustrating an example of the stack determination and the driving force control that are performed by the control device while the electric vehicle according to the second embodiment is traveling in the automatic operation; and

FIG. 7 is a timing chart relating to the driving force control for the stack in the second embodiment.

### DETAILED DESCRIPTION

In the technique disclosed in Japanese laid-open Patent Publication No. 2022-161380, when the electric vehicle is stacked during automatic operation running, there is a possibility that escape from the stack is difficult but just cutting the road surface.

### First Embodiment

The following describes a first embodiment of the electric vehicle according to the present disclosure. Note that the present disclosure is not limited to the embodiment.

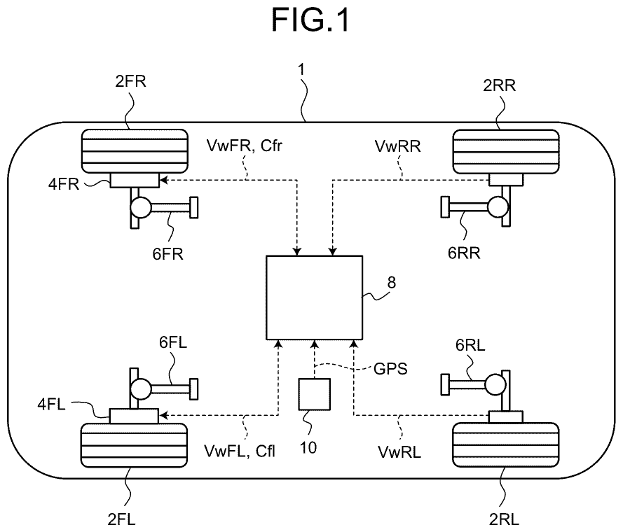

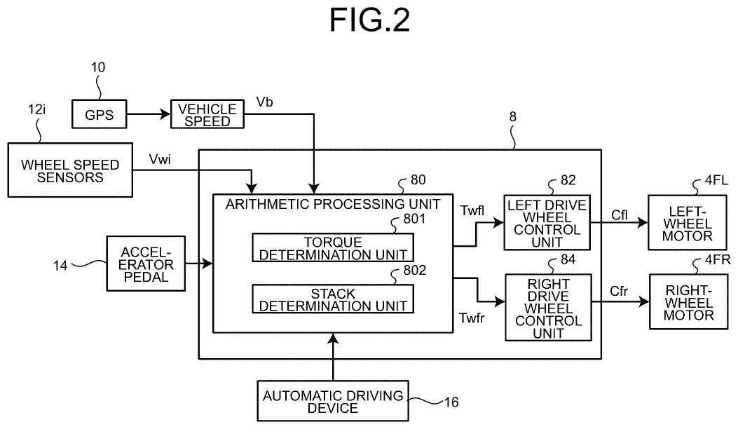

FIG. 1 is a schematic diagram illustrating an example of the schematic configuration of an electric vehicle 1 according to the first embodiment. FIG. 2 is a block diagram illustrating an example of the schematic configuration of a control system in the electric vehicle 1 according to the first embodiment.

As illustrated in FIG. 1, the electric vehicle 1 according to the first embodiment includes a left front wheel 2FL, a right front wheel 2FR, a left rear wheel 2RL, and a right rear wheel 2RR. The left front wheel 2FL and the right front wheel 2FR are provided with a left wheel motor 4FL and a right wheel motor 4FR which are in-wheel motors as rotating electric machines, respectively. The left front wheel 2FL and the right front wheel 2FR are drive wheels that are driven to rotate by a left wheel motor 4FL and a right wheel motor 4FR, respectively, supplied with power from an on-board battery or the like. The left front wheel 2FL, the right front wheel 2FR, the left rear wheel 2RL, and the right rear wheel 2RR are suspended with respect to the vehicle body by the left front suspension 6FL, the right front suspension 6FR, the left rear suspension 6RL, and the right rear suspension 6RR, respectively. A control device 8 can perform various controls related to the running of the electric vehicle 1. For example, the control device 8 controls the left-wheel motor 4FL and the right-wheel motor 4FR in response to a demand for acceleration or deceleration from the accelerator pedal 14 (see FIG. 2) by the driver or from the automatic driving device 16 to rotate and drive the left front-wheel 2FL and the right front-wheel 2FR. Thus, the left front wheel 2FL and the right front wheel 2FR exert a driving force against the road surface, thereby allowing the electric vehicle 1 to move forward or backward. A control device 5 in the electric vehicle 1 according to the first embodiment functions as a driving force control device.

Incidentally, the in-wheel motor may be provided on all of the four left and right front and rear wheels, or on the left and right rear wheels, that is, only on the left rear wheel 2RL and the right rear wheel 2RR. Further, instead of the in-wheel motor, the torque generated by a single rotating electric machine (motor generator) may be configured to rotate driven by transmitting the left front wheel 2FL and the right front wheel 2FR through a driving force transmission mechanism having a drive shaft or the like. Further, the electric vehicle 1 is provided with a steering device for controlling the steering angle of the wheels (not shown) and a braking device for generating a braking force to each wheel (not shown). As the steering device, a power steering device may be employed in the steering system to transmit the rotation of the steering wheel (not shown) actuated by the driver to the tie rods (not shown) while doubling the rotation torque thereof, and to steer the left front wheel 2FL and the right front wheel 2FR. The braking device may be of any type that provides a braking force to each wheel 2FL, 2FR, 2RL, and 2RR responsive to the depression of a braking pedal (not shown) by the driver.

The control device 8 receives detected values from various sensors for detecting a manipulated value or a stepped amount of the accelerator pedal 14, a state of a wheel such as a wheel speed Vwi (i=FL, FR, RL, and RR) from a wheel speed sensor 12i (i=FL, FR, RL, and RR) of each wheel 2FL, 2FR, 2RL, 2RR, a state of motion of the vehicle, and the like. Incidentally, the control device 8, in order to detect the vehicle speed Vb, GPS information from Global Positioning System (GPS) device 62 may be used.

Further, various parameters necessary for various controls to be executed in the electric vehicle 1, for example, the amount of depression of the brake pedal, steering angle, yaw rate, longitudinal acceleration, and various detection signals such as lateral acceleration may be input to the control device 8, and various control commands therefrom may be output to the corresponding device. Then, from the controller 8, for example, control-signals Cfl and Cfr for adjusting the torque generated by the left wheel motor 4FL and the right wheel motor 4FR is transmitted to the left wheel motor 4FL and the right wheel motor 4FR.

The controller 8 includes an arithmetic processing unit 80, a left drive wheel control unit 82, and a right drive wheel control unit 84. The arithmetic processing unit 80 includes a torque determining unit 801 and a stack determination unit 802.

The torque determining section 801 calculates and determines target values Twfl and Twfr of the torque generated by the left-wheel motor 4FL and the right-wheel motor 4FR on the basis of a stepping amount of the accelerator pedal 14 or an acceleration/deceleration request from the automatic driving device 16. Then, the torque determining unit 801 outputs a signal of the target values Twfl and Twfr of the torque generated by the left-wheel motor 4FL and the right-wheel motor 4FR to the left drive wheel control unit 83 and the right drive wheel control unit 84. The left drive wheel control unit 83 and the right drive wheel control unit 84 output control signal Cfl and Cfr for generating a torque corresponding to the target values Twfl and Twfr of the received torque to the left wheel motor 4FL and the right wheel motor 4FR, respectively.

As the automatic driving device 16, for example, a known type of vehicle capable of autonomously running (automatic driving) the electric vehicle 1 without depending on the accelerator operation of the driver using the detection result of an external sensor such as a camera can be used.

The stack determination unit 802 of the arithmetic processing unit 80 determines whether the vehicle is in a stacking state where, for example, at least one of the left front wheel 2FL and the right front wheel 2FR is fitted into such a recess. The stacking determination unit 802 refers to, for example, the wheel speeds VwFL and VwFR of the left front wheel 2FL and the right front wheel 2FR, and the vehicle speed Vb determined from the temporal change of the positional information of the electric vehicle 1 obtained by GPS device 10. Then, the stack determination unit 802 determines that the vehicle is in the stacked state when the vehicle is stopped at almost the same position at the predetermined vehicle speed or less, even though the left front wheel 2FL and the right front wheel 2FR are rotating at the predetermined rotational speed or more on the basis of the wheel speeds VwFL and VwFR and the vehicle speed Vb. For example, the stack determination unit 802 may determine that the vehicle is in a stacked state when the difference between the wheel speed Vwi and the vehicle speed Vb is equal to or more than a threshold value set in advance. The stack determination unit 802 may perform the stack determination on the basis of the detection result of the longitudinal acceleration sensor provided in the electric vehicle 1.

In the electric vehicle 1 according to the first embodiment, when the stack determination is made during the automatic operation running by the automatic driving device 16, the driving force control by the control device 8 is switched from the normal driving force control to the driving force control for the stack. In this stacking drive control, the torque variation is intentionally repeated to raise or lower the torque generated by the left-wheel motor 4FL and the right-wheel motor 4FR.

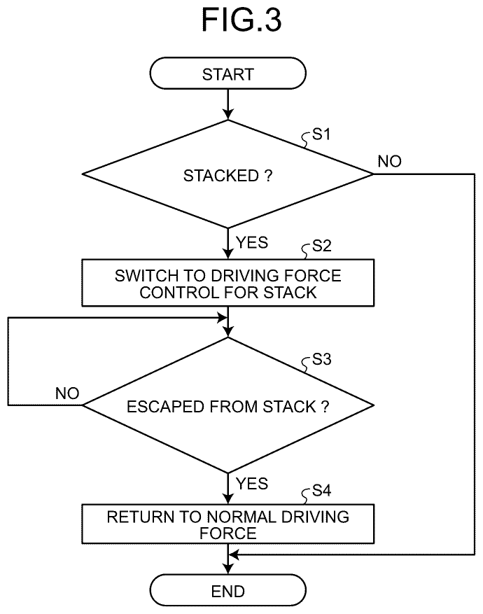

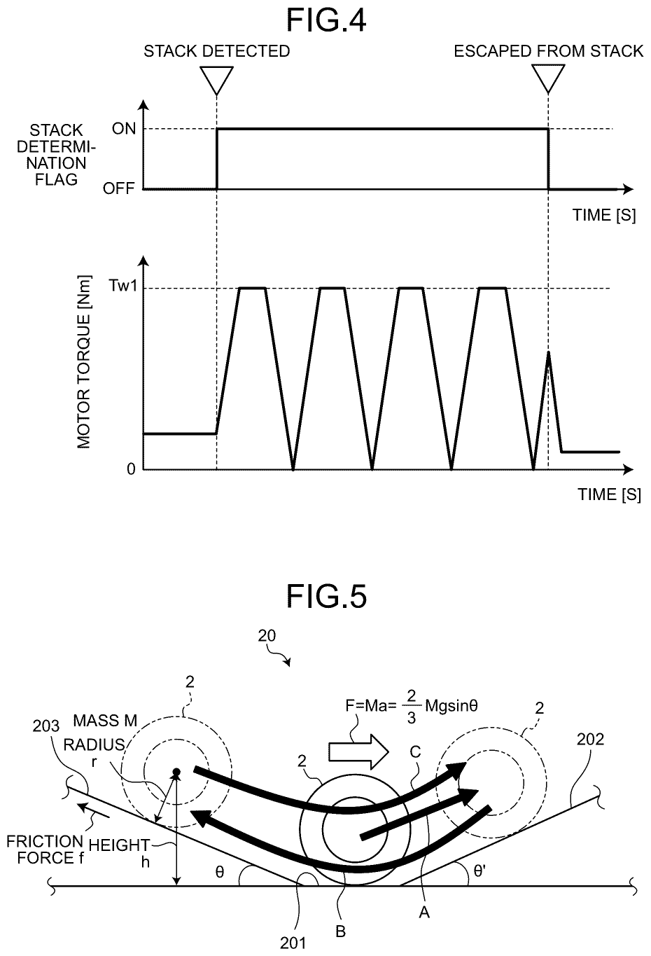

FIG. 3 is a flowchart illustrating an example of the stack determination and the driving force control that are performed by the control device 8 while the electric vehicle 1 according to the first embodiment is traveling in the automatic operation. FIG. 4 is a timing chart relating to driving force control for the stack in the first embodiment. FIG. 5 is a diagram illustrating a state of the driving wheels 2 when the driving force control for the stack is executed.

First, the control device 8, during the automated driving of the electric vehicle 1, at least one of the left front wheel 2FL and the right front wheel 2FR is determined whether it is stacked (step S1). The controller 8, if it is determined that is not stacked (No in step S1), and terminates the series of control. On the other hand, when it is determined that it is stacked (Yes in step S1), the control device 8 switches the driving force control of the left-wheel motor 4FL and the right-wheel motor 4FR from normal driving force control to driving force control for the stack (step S2).

In the driving force control for stacking, as illustrated in FIG. 4, the control device 8 alternately switches the torque of the left-wheel motor 4FL and the right-wheel motor 4FR between 0 Nm and torque Tw1 Nm to increase and decrease the rotational driving force of the left front wheel 2FL and the right front wheel 2FR. Thus, for the left front wheel 2FL and right front wheel 2FR the slope 202, by increasing the motor torque in the torque Tw1 from being fitted in the recess 20 so that as illustrated in FIG. 5, the driving wheel 2 claims the slope 202 of the front from the bottom 201 of the recess 20 as indicated by arrow A in FIG. 5. Thereafter, by lowering the motor torque from the torque Tw1 to 0, as indicated by arrow B in FIG. 5 by the controller 8, the drive wheel 2 is rolled down from the front slope 202 to the bottom 201, so that the driving wheel 2 climbs the rear slope 203 by the momentum at that time. Then, by raising the motor torque to the torque Tw1 by the control device 8 again, in addition to the rotational driving force acting on the driving wheel 2 by the torque Tw1 generated by the left-wheel motor 4FL and the right-wheel motor 4FR, a force acting on the driving wheel 2 rolling down from the rear slope 203 toward the bottom 201, in other words, the inertia of the electric vehicle 1 to advance is superimposed, as indicated by the direction of arrow C in FIG. 5, so that the driving wheel 2 climbs the slope 202 of the front.

Next, the controller 8, while executing the driving force control for the stack, determines whether the left front wheel 2FL and the right front wheel 2FR has escaped from the stack (step S3). When the controller 8 determines that it is not escaped from the stack (No in step S3), the controller 8 continuously executes the driving force control for the stack, and repeatedly execute the process of step S3 until determining that the wheel is escaped from the stack. When the controller 8 determines the escape from the stack (Yes at step S3), the process returns to the normal driving force control (step S4). Then, the control device 8 terminates the series of the control. As described above, in the electric vehicle 1 according to the first embodiment, when the stack determination is made during the automatic operation running, the driving force control by the control device 8 is switched from the normal driving force control to the driving force control for the stack. Thus, in the electric vehicle 1 according to the first preferred embodiment, a reaction is used in addition to the rotational driving force of the left front wheel 2FL and the right front wheel 2FR to facilitate escape from the stacking during autonomous driving.

Further, in the electric vehicle 1 according to the first exemplary embodiment, when the vehicle 1 is stacked during the automatic operation running and continues to be rotated so that the left front wheel 2FL and the right front wheel 2FR are advanced by the normal driving force control, an excessive cutting of the road surface is suppressed and a deterioration of the stack can also be suppressed. Further, in the electric vehicle 1 according to the first embodiment, since the left-wheel motor 4FL and the right-wheel motor 4FR are not rotated at a high rotational speed during stacking during autonomous operation, the loads on the left-wheel motor 4FL and the right-wheel motor 4FR are reduced, thereby preventing adverse effects on durability.

### Second Embodiment

The following describes a second embodiment of the electric vehicle according to the present disclosure. In the electric vehicle 1 according to the second embodiment, similarly to the electric vehicle 1 according to the first embodiment illustrated in FIG. 1, only at the left front wheel 2FL and the right front wheel 2FR, the left wheel motor 4FL and the right wheel motor 4FR is provided which is an in-wheel motor. Incidentally, in the electric vehicle 1 according to the second embodiment, the same description as the electric vehicle 1 according to the first embodiment will be omitted as appropriate.

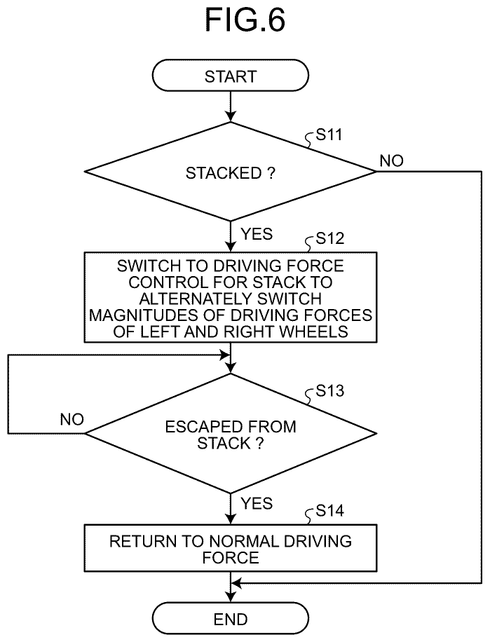

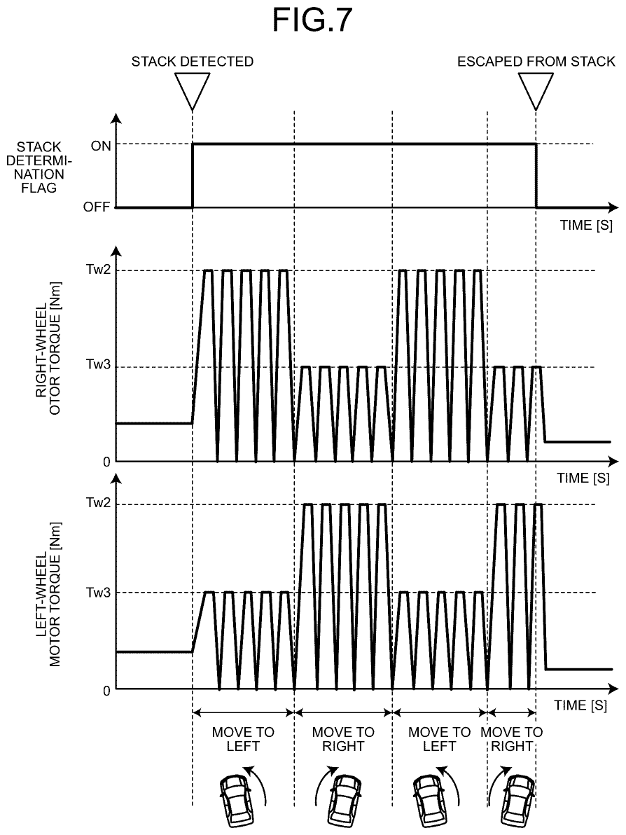

FIG. 6 is a flowchart illustrating an example of the stack determination and the driving force control that are performed by the control device 8 while the electric vehicle 1 according to the second embodiment is traveling in the automatic operation. FIG. 7 is a timing chart relating to driving force control for the stack in the second embodiment.

First, during the automated driving of the electric vehicle 1, the control device 8 determines whether at least one of the left front wheel 2FL and the right front wheel 2FR is stacked (step S11). When the controller 8 determines that it is not stacked (No in step S11), the series of the control is terminated. On the other hand, the control device 8, when determining that it is stacked (Yes in step S11), the controller 8 switches the driving force control from the normal driving force control to the driving force control for the stack to make the magnitude of the rotational driving force of the left front wheel 2FL different from the magnitude of the rotational driving force of the right front wheel 2FR at the same timing (step S12).

In the driving force control for stacking in the second embodiment, as illustrated in FIG. 7, the control device 8 alternately switches the torque of the right wheel motor 4FR by raising and lowering between 0 and torque Tw2 so as to increasing and decreasing the rotational driving force of the right front wheel 2FR to drive the right front wheel 2FR for a certain period of time. The torque of the left-wheel motor 4FL is alternately lowered and raised between 0 and a torque Tw3 (>0), which is smaller than the torque Tw2, and the rotational driving force of the left front wheel 2FL is increased and decreased to drive the left front wheel 2FL for a certain period. Incidentally, with respect to the torque of the right-wheel motor 4FR and the torque of the left-wheel motor 4FL, the timing of raising the timing and lowering the timing are synchronized to the same timing. Thus, the difference in the rotational driving force between the left front wheel 2FL and the right front wheel 2FR allows the electric vehicle 1 to move toward the left while moving forward. Thereafter, the control device 8 alternately switches the torque of the right wheel motor 4FR by raising and lowering between 0 and the torque Tw3, and increases and decreases the rotational driving force of the right front wheel 2FR to drive the right front wheel 2FR for a certain period. And, the control device 8 alternately switches the torque of the left wheel motor 4FL by raising and lowering between 0 and the torque Tw2, and increases and decreases the rotational driving force of the left front wheel 2FL to drive the left front wheel 2FL for a certain period. Thus, the difference in the rotational driving force between the left front wheel 2FL and the right front wheel 2FR allows the electric vehicle 1 to move toward the right while moving forward. Then, the control device 8 differs in the magnitude of the torque generated by the left-wheel motor 4FL and the right-wheel motor 4FR at such the same timing, by the difference in rotational driving force between the left front wheel 2FL and the right front wheel 2FL, so that the driving force control such that the electric vehicle 1 can move toward the left side while moving forward and the driving force control such that the electric vehicle 1 can move toward the right side while moving forward, are executed alternately repeatedly.

Next, the controller 8, while executing the driving force control for the stack, determines whether the left front wheel 2FL and the right front wheel 2FR has escaped from the stack (step S13). The controller 8, when it is determined that it is not escaped from the stack (No in step S13), continuously executes the driving force control for the stack to repeat the determination in step S13 until it is determined that it is escaped from the stack. The controller 8, if it is determined that it is escaped from the stack (Yes in step S13), returns to the normal driving force control (step S14). Then, the control device 8 terminates the series of the control.

As described above, in the electric vehicle 1 according to the second embodiment, when the stack determination is made during the autonomous driving, the driving force control by the control device 8 is switched from the normal driving force control to the driving force control for the stack in which the magnitude of the rotational driving force in the left front wheel 2FL and the right front wheel 2FR is alternately changed. Thus, in the electric vehicle 1 according to the second embodiment, the left front wheel 2FL and the right front wheel 2FR can be easily hooked on the slope of the recess by sawing (driving force in the lateral direction) due to differences in rotational driving force, thereby increasing the stacking escape capability.

Further, in the electric vehicle 1 according to the second exemplary embodiment, since the driving force control for the stack is implemented, it is not necessary to perform steering for directing the electric vehicle 1 to the left and right alternately using the steering device when escaping from the stack, so that it is possible to improve the durability of the steering device.

In the electric vehicle according to the present disclosure, by utilizing the reaction in addition to the rotational driving force of the left drive wheel and the right drive wheel, an effect can be obtained that it is possible to easily escape from the stack during automatic operation running.

According to the present disclosure, the reaction can be utilized in addition to the rotational driving force of the left drive wheel and the right drive wheel to facilitate escape from the stack during automatic operation running.

According to the present disclosure, it is possible to increase the stack escape capability by taking out the sawing effect due to the difference in the rotational driving force of the left drive wheel and the right drive wheel.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric vehicle that has rotating electric machines for generating rotational driving forces to be applied to a left drive wheel and a right drive wheel of the electric vehicle, and that travels in an automatic operation, the electric vehicle comprising a controller configured to, when determining that at least one of the left drive wheel and the right drive wheel is stacked during traveling in the automatic operation, perform, in response to the stack, driving force control for rotating and driving the left drive wheel and the right drive wheel by increasing and decreasing torques generated by the rotating electric machines.

2. The electric vehicle according to claim 1, wherein
the rotary electric machines include a left wheel in-wheel motor and a right wheel in-wheel motor, which are provided on the left drive wheel and the right drive wheel, respectively, and
the controller performs the driving force control in a manner that a magnitude of a torque to be generated in the left wheel in-wheel motor is different from a magnitude of a torque to be generated in the right wheel in-wheel motor at a same timing.
